(19) United States
(12) Patent Application Publication
(10) Pub. No.: US 2025/0382155 A1
(43) Pub. Date: Dec. 18, 2025

(54) STAIRLIFT DEVICE CONTROLLABLE ACCORDING TO PREDEFINED CONTROL PROFILES AS WELL AS METHOD AND COMPUTER PROGRAM AND USE

(71) Applicant: TK HOME SOLUTIONS B.V., Krimpen aan den IJssel (NL)

(72) Inventors: Wilco Van Eijgen, Rijnsburg (NL); Cornelis Boxum, Delfgauw (NL)

(21) Appl. No.: 18/877,010

(22) PCT Filed: Jun. 19, 2023
(86) PCT No.: PCT/EP2023/066511

§ 371 Date: Dec. 19, 2024

(30) Foreign Application Priority Data
Jun. 21, 2022 (EP) 22180151.7

(51) Int. Cl. B66B 9/08

(52) U.S. Cl. CPC B66B 9/0807

(57) ABSTRACT

The present disclosure relates to a stairlift device configured for being controlled according to a plurality of predefined control profiles, wherein the stairlift device exhibits a drive unit and a control unit, wherein at least two or three individual or predefined control profiles are deposited or stored in the control unit, wherein the control unit is configured to control at least one of the drives according to predefined settings or parameters of a respective control profile, when a/the respective control profile is in activated state, wherein a/the respective control profile is activated according to at least one condition from the following group: a user selecting, the stairlift device autonomously detects at least one condition or parameter or predefined relative position, a momentary situation falls within a predefined time frame, user/remote control operation. The present disclosure relates to corresponding means and methods for controlling the stairlift device.

### CROSS-REFERENCE TO RELATED APPLICATIONS

This application is Continuation-In-Part of the U.S. National Phase of PCT/EP2023/066511 filed Jun. 19, 2023, which claims priority to European Patent Application No. 22180151.7, filed Jun. 21, 2022, the entire content of both are incorporated herein by reference in their entirety

### TECHNICAL FIELD

The present disclosure refers to a stairlift device, and more particularly to a stairlift device configured for being controlled according to a plurality of predefined control profiles.

### BACKGROUND

Some current stairlifts are equipped with a rotatable chair, enabling the stairlift to rotate the chair such as the seat before, after and during the ride. The rotation of the chair is being referred to as swivelling (motion), corresponding to a pivot motion around an at least approximately vertical axis. For example, in a stairlift system exhibiting a monorail with different inclination angles, the chair frame is rotatably connected to an automatically levelled pedestal of the drive. The footrest is connected to the chair frame via the chair leg and the seat. Usually, the chair is foldable; when the chair is folded, the footrest, chair leg and seat are stowed in front of the backrest. The stairlift moves along a rail within a staircase in order to surmount the stairs. When swivelling, the footrest rotates along with the seat. This swivel motion also allows the stairlift for moving through narrow staircases, especially by rotating the complete chair towards the valley side of the staircase; as a result, the required width of the staircase is determined by the width of the chair, which is (usually) less than the space needed by the footrest in a non-swivelled chair orientation. Moreover, when the chair is swivelled towards the valley side of the staircase, the footrest hovers over lower steps than the seat; as a result, the rail can be positioned lower, without having a collision between the footrest and the step noses. A lower positioned rail results in a lower positioned seat and provides for better visual appearance of the rail and also for a safer user experience.

In order to move the stairlift properly, for instance through a staircase, drive speed values as well as swivel angles can be predefined and/or programmed in the drive resp. in a control unit of the stairlift, especially predefined values relating to the position of the drive with respect to the rail. As a result, the stairlift will always behave equally at each position along the rail. Nonetheless, such a configuration may not be convenient for all common use cases. For instance when the stairlift is positioned upstairs with its chair folded and the user wants to call the stairlift using a remote control device, during approach, until now, the stairlift slows down in corners and carries out several swivel movements (which takes extra time). Another situation which should be optimized is when the stairlift in installed, for instance in a stairwell, for multiple users each having an own (individual) front door (apartment door); each user probably prefers the stairlift swivelling (by default) towards his/her own front door when arriving and not to swivel towards any front door of any neighbour. In other words: There is a need for stairlift devices being able to carry out individual movements/motions according to specific situations or user requirements.

Previously known stairlifts may already include some user specific settings or some control presetting depending on momentary situations. EP 1 197 465 B1 describes a seat capable of being pivoted up and downward on a substantially horizontal pivot axis. EP 1 725 491 B1 describes stairlifts being configured for swivelling the chair e.g., seat during the ride. WO 2019/238736 A1 and EP 3 178 770 A1 describe individual control parameters especially relating to travelling speed or rotational movement of a stairlift.

Prior art publications DE 195 13 920 A1, EP 3 915 924 A1, WO 2021/259841 A1 describe means and methods for controlling stairlift devices, especially in context with personal signal emitters, especially in order to render individual stairlift control more efficient and more specific or more safe.

Nonetheless, previously known configurations do not yet allow for extensive individual and/or situation-dependent control and straightforward processing of the stairlift's way of motion and positioning.

### SUMMARY

It is an object of the present disclosure to provide for enhanced control for stairlift devices, especially in context with individualisation of the stairlift's manner of motion and positioning. In particular, a/the object of the present disclosure is to provide for devices and methods allowing for controlling a stairlift such that the stairlift behaves and moves in optimum manner depending on momentary situations and/or user preferences, especially by referring to driving parameters.

The object of the disclosure is solved by the features of the independent main claims. Advantageous features are indicated in the subclaims. The features of the subclaims can be combined with the features of the main claims and further subclaims.

In particular, the object is therefore solved by a stairlift device configured for being controllable/controlled according to a plurality of predefined control profiles, wherein the stairlift device exhibits/includes a drive unit including a plurality of drives or actuators and further exhibits a control unit and a data storage unit, wherein the drive unit is in communication with the control unit, wherein at least two or three individual or predefined control profiles, especially speed and/or swivel profiles, are deposited resp. stored in the data storage unit and are available/retrievable from the data storage unit via the control unit, wherein the control unit is configured to control at least one of the drives according to predefined settings or parameters matching with (according to) a respective control profile, when a/the respective control profile is in active state activated by the control unit or by a user, wherein a/the respective control profile is activated depending on (resp. according to) at least one condition from the following group: the stairlift device autonomously detects at least one condition or parameter being correlated with one specific of the predefined control profiles (especially via at least one sensor integrated in the stairlift device and connected to the control unit, and/or via at least one individual “log on” key as e.g. an RFID device carried by a user), a momentary situation falls within a predefined time frame correlated with one specific of the predefined control profiles, at least one of the components of the stairlift device (especially the chair) is in a predefined relative position being correlated with one specific of the predefined control profiles (e.g. swivelled, tilted, folded, unfolded), the stairlift device is operated via remote control or joystick (or any other likewise user control device being present on the carriage, i.e. on the moving parts of the system). This also allows for controlling the stairlift such that it behaves in optimum manner according to at least one of the control profiles which is chosen depending on a momentary situation and/or depending on user preferences, especially also involving individual adaptation of speed and movement patterns. The stairlift's movement can be predefined in a user-specific manner by referring e.g. to the driving speed and the swivelling motion. This may also include individual automatic chair height settings.

In other words: The present disclosure is based on the concept of providing multiple speed profiles and/or (swivel) motion profiles which can be activated depending on the situation and/or depending on individual user preferences (i.e., depending on at least one condition which can be predefined by a user or which can be detected by the stairlift device itself). For instance, in context with a kind of standard profile, in case a chair of the stairlift device is unfolded (or at least some of the components of the stairlift device being unfolded) and the stairlift device can be operated with either a remote control or a joystick (or any other likewise user control device being present on the carriage, i.e. on the moving parts of the system), controlling is based on a (first) control profile including a swivel profile in which the chair swivels before, during or after the ride along the rail in order to avoid collision with any step noses and/or to position the chair properly for safe (de) boarding by the user and/or to position the chair for (un) stowing it compactly in the staircase. For instance, in context with a kind of fast call or fast park profile (e.g. in order to save time and/or to economize energy, at least based on resp. due to reduced swivel movements), especially in case the chair is completely folded and the stairlift device is operated by a/the remote control, the stairlift device is actuated according a (second) control profile including a specific swivel profile according to which the chair does not rotate/swivel during the ride (and therefore does not have to slow down that much), and, for example, only swivels towards a/the user when arriving at the boarding position (especially within a landing area). This control/swivel profile can also be used and/or retrieved (such as taken as a basis for any controlling process) for sending the stairlift device to a parking position halfway the stairs (or just somewhere between boarding positions or landing areas). For instance, in context with a kind of customized user profile, in case a stairlift installation is provided for multiple users, a (third) control profile including a speed and/or swivel motion profile is used resp. retrieved which is related to an individual user present on the chair. Thus, the present disclosure is based on the concept of providing at least two or three control profiles, especially including specific speed and/or swivel profiles, which are available/retrievable from a data storage unit and which can be chosen and processed by means of a logic unit or a computer (program).

It should be noted that according to the present disclosure, the term/expression “to exhibit” may involve the expression “to comprise” or “to have”.

It has been found that the concept of the present disclosure can also be combined in advantageous manner with specific user profiles already elaborated in context with stairlift installations, as e.g. described in prior art especially in WO 2019/238736 A1 or EP 3 178 770 A1, especially in order to provide for a kind of standardized database also, which can be used by a plurality of users and/or which can be implemented for a plurality of stairlift systems.

The control profiles are stored according to a specific ranking/hierarchy, which can be defined depending on preferences of a user or situation, e.g. security preferences or energetic preferences or preferences relating to saving of time. Thus, choosing one of the control profiles may also be carried out based on this ranking, e.g. in case a (pre-)condition or situation allows for alternatively choosing several control profiles.

According to one embodiment, at least one of the three following individual or predefined control profiles is stored in the data storage unit and can be retrieved by the control unit depending on at least one condition or depending on a specific user selection: standard profile (y including swivel motions, especially depending on unfolded chair), fast call/park profile (exempt swivel motions, especially depending on completely folded chair), at least one customized user profile (referring to individual path of motion in multi user constellations). The stairlift device is controllable according to any of these control profiles. This variability also allows for good customisability for individualisability.

According to one embodiment the stairlift device exhibits a foldable chair having at least one of the following components: footrest, chair leg, seat and backrest, armrest; wherein at least one specific relative position of at least one of these components is correlated with a condition or parameter or with one specific of the predefined control profiles. This kind of interdependency and/or correlation also allows for (self-acting, machine-aided) consideration of specific momentary situations and conditions relating to the manner of using the stairlift device. The seat may rotate with respect to the backrest, especially when (un) folding.

According to one embodiment the stairlift device exhibits at least the following drives (or actuators, respectively): main drive for driving the stairlift device along a/the rail, swivel drive for swivelling a/the chair of the stairlift device, levelling/tilting drive for tilting the chair; wherein the stairlift device and components thereof, e.g., the control unit is configured for individually controlling each of these drives according to predefined settings or parameters matching with a respective control profile, when a/the respective control profile is in active state activated by the control unit or by a user. This also allows for a high variability as to specific movement patterns. It should be noted that a/the levelling behaviour may remain standardised (in particular, the chair is levelled horizontally at all times). Nonetheless, when referring to special feature like enhanced (de) boarding, also the levelling behaviour can be individualised according to user-specific demands.

According to one embodiment at least one of the control profiles includes a plurality of speed parameters and/or a plurality of swivel motion parameters, wherein a respective individual speed parameter and/or swivel motion parameter is correlated with at least one of a specific time frame, a specific relative position along a/the rail, a specific user, a specific measurement value or sensor data, presence of a/the user on the chair of the stairlift device, un-/folded state of at least one component of the stairlift device. This may render each control profile even more individual and may provide for even more specific and sophisticated control. The stairlift device can include a sensor unit exhibiting a plurality of sensors which may e.g. provide sensor data relating to a momentary situation of the chair and/or to any object or individual and/or to any risk of collision. Thus, a movement pattern predefined according to at least one of the control profiles may also be adapted automatically, based on momentary sensor data.

According to the disclosure, the control unit of the stairlift device is configured for activating a specific one of the control profiles depending on the stairlift device autonomously detecting at least one condition or parameter referring to at least one relative position or state of at least one component of the stairlift device, especially depending on an un-/folded and/or un-/closed state of at least one component of the stairlift device. In addition, the at least one condition or parameter may also refer to any object or individual and/or to any risk of collision, especially by means of a sensor unit of the stairlift device providing for momentary sensor data (in particular position data, distance data, speed data, inclination data e.g. referring to momentary inclination of the seating area with respect to at least one axis, contact data e.g. referring to contact of an individual with/on the seating area of the chair). This kind of on-line diagnosis or detection process also allows for rendering the movement patterns even more specific, be it within the predefined scope of a specific one of the control profiles, be it departing therefrom and considering e.g. a risk of collision and therefore deciding to adapt the movement pattern.

In particular, the above mentioned object is therefore also solved by a stairlift control unit configured for controlling a stairlift device according to a plurality of predefined control profiles, especially in a stairlift device as described above, wherein the stairlift control unit is configured for controlling a drive unit of the stairlift device including a plurality of drives or actuators, wherein the stairlift control unit is configured to communicate with the drive unit, wherein at least two or three individual or predefined control profiles, especially speed and/or swivel profiles, are deposited/stored in the stairlift control unit, wherein the stairlift control unit is configured to control at least one of the drives or actuators according to predefined settings or parameters matching with a respective control profile, when a/the respective control profile is in active state activated by the stairlift control unit, wherein the stairlift control unit is configured to activate a/the respective control profile depending on at least one condition from the following group: the stairlift control unit autonomously detects at least one condition or parameter being correlated with at least one specific of the predefined control profiles, a momentary situation falls within a predefined time frame correlated with at least one specific of the predefined control profiles, the stairlift control unit detects at least one of the components of the stairlift device being in a predefined relative position correlated with at least one specific of the predefined control profiles, stairlift control unit detects the stairlift device being operated via remote control or joystick (or any likewise control unit being present on the carriage, e.g. a set of push buttons or a voice control unit or the like). These features provide for above mentioned advantages especially also in view of individual enhanced control of already installed (built-in) stairlifts, e.g. by retrofitting such a control unit in already installed systems.

The control unit is configured for activating a specific one of the control profiles depending on at least one autonomously detected condition or parameter referring to at least one relative position or state of at least one component of the stairlift device, especially depending on an un-/folded and/or un-/closed state of at least one component of the stairlift device.

In particular, the above mentioned object is therefore also solved by a method for controlling the motion of a stairlift device, especially of a stairlift device as described above, according to at least one movement pattern according to an individual one of a plurality of predefined control profiles, especially speed and/or swivel profiles, the method including: controlling a drive unit of the stairlift device for carrying out at least one motion or actuation for moving or arranging the stairlift device, especially a chair or seat of the stairlift device, according to a predefined path of motion, especially at least controlling a first drive for driving the stairlift device along a rail and positioning the stairlift device in a boarding position in a landing area on the rail, the method further including controlling at least one further drive or actuator for moving (resp. rotating, swivelling, tilting) the chair or seat around at least one spatial direction/axis, especially for swivelling the chair or seat around a swivel axis and for tilting the chair or seat around a tilting axis, wherein the method further comprises: controlling at least one of the drives or actuators according to predefined settings or parameters matching with a respective control profile, when a/the respective control profile is in active state, and activating a/the respective control profile depending on at least one condition from the following group: at least one condition or parameter being correlated with at least one specific of the predefined control profiles is autonomously detected, a momentary situation falls within a predefined time frame correlated with at least one specific of the predefined control profiles, at least one of the components of the stairlift device is detected being in a predefined relative position correlated with at least one specific of the predefined control profiles, the stairlift device is detected to be operated via user control or remote control. These features provide for above mentioned advantages especially also in view of enhanced control and optimized user interaction also in multiple users scenarios. The method may include not only the behaviour of preparing for getting seated, but also the behaviour of un-tilting (and swivelling) when the user is seated. The latter may be operated via a user control on the chair (e.g. joystick); the first behaviour may be operated via a remote control.

In context with the method steps of the present disclosure, it should be noted that the disclosure refers both to the behaviour of preparing the stairlift's chair for getting seated and to the behaviour of (un-) folding and tilting (and swivelling) especially with the user being seated (when the user is being seated, (un-) folding does not apply); the latter may be operated via a user control on the chair (e.g. joystick); the first behaviour (preparation) may be operated via the remote control; preparation may include all of swivelling, (un-) folding and tilting movements. In this context, it should also be noted that the present disclosure also applies for the stairlift's behaviour of preparing the stairlift's chair for leaving the chair (swivelling away from the stairs). It also applies for the behaviour of stowing the chair, e.g. in addition to folding the chair. For example, the chair is in favourable rotational position with the backrest in parallel with the rail, in order to obtain a compact folded package when being stowed at a parking position somewhere along the rail. It should also be noted that (un) folding of the seat may not apply when the user is seated, but (un) folding the footrest can/does apply at such a situation, since usually, the user is standing just before the chair before getting seated; in such a situation the footrest is folded or is actuated to be folded, and the seat is unfolded. Next, the user gets seated and unfolds the footrest, or the footrest is actuated to unfold. Finally, the user puts his/her feet on the footrest.

According to the disclosure, at least one of the three following individual or predefined control profiles is stored in a data storage unit for being activated depending on at least one condition: standard profile especially matching with a stairlift device being at least partly unfolded, fast call/park profile especially matching with a stairlift device being in a completely folded state, at least one customized user profile matching with an individual user or with a user of a predefined user group. This also facilitates user interaction in predefined situations, e.g. in context with user remote control. In addition, activation can also be carried out depending on a corresponding specific user selection.

Individual control profiles being defined according to predefined user groups may also facilitate multiple user scenarios, e.g. use of the stairlift device according to individual (and respectively most appropriate) control profiles by a plurality of persons aged within the ranged of 51 and 60 years or 61 and 70 years or 71 and 80 years or 81 and 90 years or 91 and 100 years (and so on) and/or having a weight in the range of 41 to 50 kg or 51 to 60 kg or 61 to 70 kg or 71 to 80 kg (and so on). Such group definitions may also facilitate defining, by default or as most preferred standard setting, a most favourable control profile e.g. for a user being aged within the range of 81 and 90 years and having a weight in the range of 71 to 80 kg, especially as to speed of travel.

According to one embodiment at least one predefined control profile is activated depending on detection of a folded or unfolded state of at least one of the following components of the stairlift device: footrest, chair leg, seat and backrest, armrest; wherein at least one specific relative position of at least one of these components is correlated with a condition or parameter or with one specific of the predefined control profiles.

According to one embodiment at least one of the following drives (or actuators, respectively) is actuated based on at least one of the control profiles: main drive for driving the stairlift device along a/the rail, swivel drive for swivelling a/the chair of the stairlift device, levelling/tilting drive for tilting the chair; wherein each of these drives is individually controlled according to predefined settings or parameters matching with a respective control profile, when a/the respective control profile is in active state activated by a/the control unit or by a user. This also provides for a high degree of customisability.

According to one embodiment the stairlift device is controlled according to a plurality of speed parameters and/or a plurality of swivel motion parameters, wherein a respective individual speed parameter and/or swivel motion parameter is correlated with at least one of a specific time frame, a specific relative position along a/the rail, a specific user, a specific measurement value or sensor data, presence of a/the user on the chair of the stairlift device, un-/folded state of at least one component of the stairlift device.

According to one embodiment the method is a computer-implemented method providing program instructions to a/the control unit of the stairlift device.

The above mentioned object is therefore also solved by a computer program including instructions which, when the program is executed by a control unit of a stairlift device according to the present disclosure, cause the control unit to execute the steps of a method as described above.

In particular, the above mentioned object is therefore also solved by use of a plurality of predefined control profiles, especially speed and/or swivel profiles, for individually controlling at least one drive or actuator of a stairlift device, especially of a stairlift device as described above, according to at least one movement pattern according to an individual one of the plurality of predefined control profiles, especially according to a method for controlling as described above, wherein at least two motions or actuations for arranging a chair or seat of the stairlift device are controlled, wherein at least a first drive is controlled for driving the stairlift device along a rail and positioning the stairlift device in a boarding position in a landing area on the rail, wherein at least one further drive or actuator for moving (resp. rotating, swivelling, tilting) the chair or seat around at least one spatial direction/axis is controlled for rotating the chair or seat around a swivel axis and/or for tilting the chair or seat around a tilting axis, wherein at least one of the drives or actuators is controlled according to predefined settings or parameters matching with a respective control profile, when a/the respective control profile is in active state, wherein a/the respective control profile is activated depending on at least one condition from the following group: at least one condition or parameter being correlated with at least one specific of the predefined control profiles is autonomously detected, a momentary situation falls within a predefined time frame correlated with at least one specific of the predefined control profiles, at least one of the components of the stairlift device is detected being in a predefined relative position correlated with at least one specific of the predefined control profiles, the stairlift device is detected to be operated via remote control or a user control provided on the chair (especially joystick). These features provide for above mentioned advantages especially also in view of facilitated customisability resp. individualisability of a plurality of different kinds of stairlift devices.

Abstract: The present disclosure relates to a stairlift device configured for being controlled according to a plurality of predefined control profiles, wherein the stairlift device exhibits a drive unit and a control unit, wherein at least two or three individual or predefined control profiles are deposited or stored in the control unit, wherein the control unit is configured to control at least one of the drives according to predefined settings or parameters of a respective control profile, when a/the respective control profile is in activated state, wherein a/the respective control profile is activated according to at least one condition from the following group: a user selecting, the stairlift device autonomously detects at least one condition or parameter or predefined relative position, a momentary situation falls within a predefined time frame, user control operation resp. remote control operation (i.e., either a remote control or a control unit arranged on the chair can be used). The present disclosure relates to corresponding means and methods for controlling the stairlift device.

### SHORT DESCRIPTION OF FIGURES

These and other aspects of the present disclosure will also be apparent from and elucidated with reference to the embodiments described hereinafter. Individual features disclosed in the embodiments can constitute alone or in combination an aspect of the present disclosure. Features of the different embodiments can be carried over from one embodiment to another embodiment. In the drawings:

FIG. 1 shows specific steps of a method for controlling a stairlift device according to embodiments;

FIG. 2 shows in a side view in schematic illustration the use of a stairlift device according to one embodiment;

FIG. 3A schematically illustrates in a side view of a stairlift device illustrating a levelling/tilting motion according to one embodiment;

FIG. 3B, schematically illustrates in a side view of a stairlift device illustrating a swivelling motion according to one embodiment;

FIG. 3C show respectively in a side view in schematic illustration a stairlift device illustrating am unfolding some of the components of the stairlift device according to one embodiment.

### DETAILED DESCRIPTION OF FIGURES

First, the reference signs are described in general terms; individual reference is made in connection with respective figures.

A stairlift device 10 is provided for a user 5 for overcoming a stair 1, e.g. for driving along a rail 3 from a first level/floor 1a or landing area 7 to a second level/floor 1b or landing area 7. The stair 1 includes a plurality of steps 2 respectively exhibiting a step nose 2.1. The stairlift device 10 should be able to smoothly overcome the stair 1 without any risk of colliding with any step nose 2.1 or any further object.

The stairlift device 10 includes a drive unit 11 exhibiting a first drive (main drive) 11.1 for driving the stairlift device 10 (resp. the chair 17) along the rail 3, and further exhibiting a swivel drive or actuator (further drive, especially second drive) 11.2 and a tilting/levelling drive or actuator (further drive, especially third drive) 11.3. The first drive 11.1 may be a main drive, motor, actuator, and/or the like. A sensor unit such as sensing unit 13 (e.g. including a first angle rate sensor, a second angle rate sensor, and a third sensor, especially referring to absolute and/or relative position or motion) provides for different kinds of sensor data especially referring to momentary conditions or parameters.

The stairlift device 10 exhibits a footrest 15 and a chair 17 including a seat 17.1 (resp. seating area/plane) and a backrest 17.3 and an armrest 17.5 and a chair leg 17.7.

The stairlift device 10 further exhibits a control unit 19 including a data storage unit 19.3. The stairlift device 10 may also include a user control 19.1 (e.g. remote control) and/or a user control on the chair (e.g. a joystick, not explicitly shown in the figures) for further facilitating controlling/commanding the stairlift device by a user.

The control unit 19 may be an electronic control unit (ECU), a central processing unit (CPU), and the like, for performing the functions as described herein. As such, the control unit 19 may be configured to receive, analyze and process sensor data, perform calculations and mathematical functions, convert data, generate data, control system components (e.g., the drive unit 11, the first drive 11.1, the swivel drive or actuator (further drive, especially second drive) 11.2 and the tilting/levelling drive or actuator (further drive, especially third drive) 11.3, and the like), and the like. The control unit 19 may include one or more processors, and other components, for example one or more memory modules that stores logic that is executable by the one or more processors and a database (e.g., the data storage unit 19.3) based on, for example, received sensed data from the sensor unit 15. Each of the one or more processors may be a controller, an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the one or more processors.

The computer-executable instructions may include logic or algorithms, written in any programming language of any generation such as, for example machine language that may be directly executed by the processors, or assembly language, object orientated programming, scripting languages, microcode, and the like, that may be compiled or assembled into computer-executable instructions and storage on the one or more memory modules. Alternatively, the computer-executable instructions may be written in hardware description language, such as logic implemented via either a field programmable gate array (FPGA) configuration or an application specific integrated circuit (ASIC), all their equivalents. Accordingly, the systems, methods, processes, and/or computer product programs described herein may be implemented in any conventional computer programming language, as preprogrammed hardware elements, or as a combination of hardware and software components. Further, provided herein is a computer program product for use with or by the control unit and/or a computer that is a central processing unit configured for controlling components of the starilift (e.g., the drive unit 11, the first drive 11.1, the swivel drive or actuator (further drive, especially second drive) 11.2 and the tilting/levelling drive or actuator (further drive, especially third drive) 11.3, and the like). The computer program product may include a computer usable medium having computer readable readable instruction or program code embodied on the computer usable medium.

The data storage unit 19.3 may generally be a data storage device, such as a data server, a data respotiory, a cloud-based sever, a physical storage device, a removable media storage device, or the like. The data storage unit 19.3 may be integrated with the control unit 19, computer, sensor unit 15 (e.g., a component of thereof) or may be a standalone unit.

According to the present disclosure, the stairlift device 10 is configured for being controlled based on a plurality of predefined/predefinable control profiles CP, especially including speed and/or swivel motion profiles. For example, for positioning in a (neutral) boarding position PB (or in any predefined position along the rail, e.g. in any position which is favourable for de-/boarding), the stairlift device 10 can be controlled according to a fast call/park profile. For example, for arranging the chair in a de-/boarding position PB1, the stairlift device 10 can be controlled according to a customized user profile, wherein the chair may carry out e.g. a specific motion in order to specifically arrange the seating area for comfortable de-/boarding of a specific user (e.g. in view of the user's age and/or size and/or physical capabilities). For example, for positioning in an intermediate position Pi (in height) between two levels or floors, the stairlift device 10 can be controlled according to a control profile sending the stairlift device 10 in/to a kind of standby modus/position in which the stairlift device 10 can be activated in easy/fast manner both from an upper floor and from a lower floor.

In particular, the present disclosure may include at least some of the following steps for controlling the stairlift device 10 according to specific control profiles depending on individual momentary situations: step S0 moving/calling the stairlift device to/from (de-)boarding position; step S1 driving motion along the rail (especially including passenger); step S2 swivelling motion (with or without passenger); step S3 tilting/levelling motion (with or without passenger); step S4 checking at least one (pre-)condition; step S5 identifying a user, especially an individual user; step S6 choosing a specific control profile; step S7 controlling the stairlift device according to chosen control profile;

In the figures, (x) designates the travel direction e.g., the path of motion along the rail 3, and (y) designates the cross direction, and (z) designates the vertical direction or direction orthogonal to travel direction and cross direction, and (xy) designates a horizontal plane (especially a plane of the seating area), and y 17 designates the width of the chair 17, and Y1 designates the tilting/levelling axis, and Z1 designates the swivel axis.

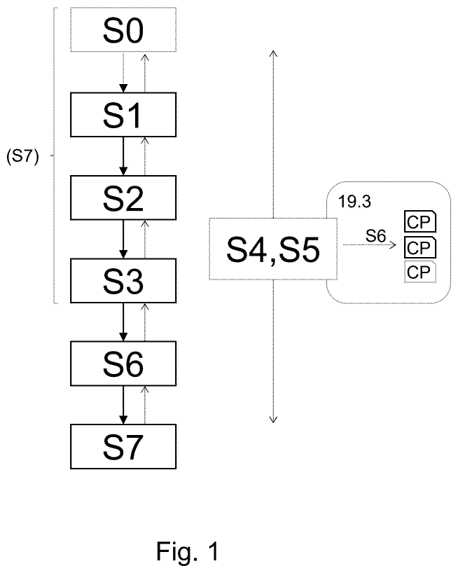

FIG. 1 illustrates some of the motions a stairlift device may carry out in order to behave in conformance with specific predefined movement patterns, especially step S1 of driving the stairlift device resp. the chair along the rail (especially including a passenger/user) and step S2 of swivelling the chair (with or without passenger) and step S3 of tilting/levelling the chair (with or without passenger). Each of these motions can be carried out in context with resp. depending on step S7 of controlling the stairlift device according to a specific control profile.

Several control profiles CP are stored in a data storage unit 19.3. The step S6 of choosing a specific control profile may be carried out especially based on any parameter acquired/evaluated in context with step S4 (checking at least one (pre-)condition) and/or step S5 (identifying a user resp. a specific user).

A process of controlling the stairlift device according to a specific control profile may be initiated, e.g., by step S0 of moving/calling the stairlift device to a (de-)boarding position and/or by any other specific user command (e.g. via remote control).

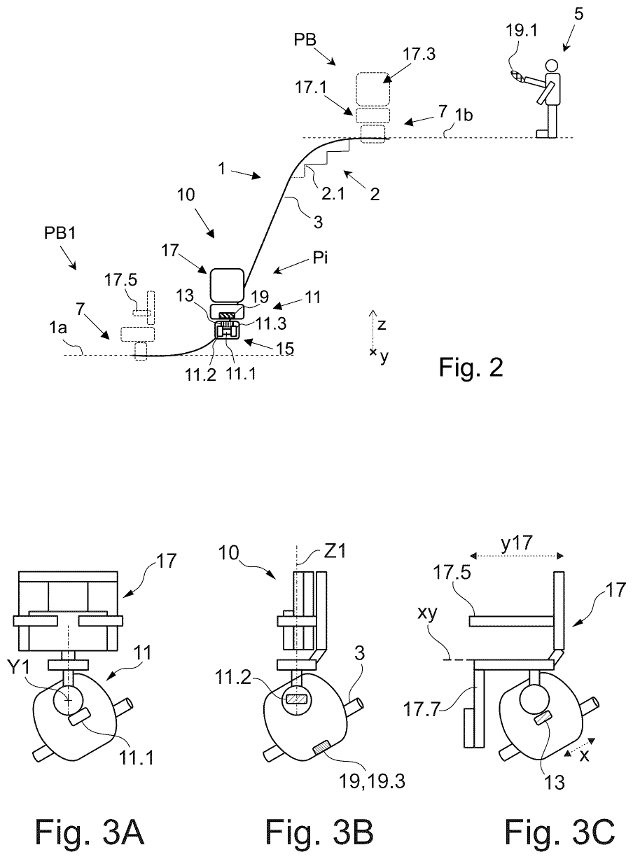

FIG. 2 illustrates some of potential relative positions and arrangements of the stairlift device 10. A user 5 may command the stairlift device 10 to achieve a specific sequence of motions according to an individual movement pattern matching with a specific control profile chosen by the user or by a/the control unit of the stairlift device 10.

In FIG. 3 some of the stairlift's motions are illustrated by referring to different axis of movement. FIG. 3A refers to a levelling/tilting motion about/around axis Y1. FIG. 3B refers to a swivelling motion about/around axis Z1. FIG. 3C refers to an unfolding of some of the components of the stairlift device, which un-/folding can be carried out manually and/or by at least one actuator.

1. A stairlift device configured for being controlled according to a plurality of predefined control profiles comprising:
a drive unit comprising a plurality of drives or actuators; a control unit; and
a data storage unit,
wherein the drive unit is in communication with the control unit, wherein at least two individual or predefined control profiles of the plurality of predefined control profiles are stored in the data storage unit and are retrievable from the data storage unit via the control unit, wherein the control unit is configured to control at least one of the drives or actuators of the plurality of drives or actuators according to predefined settings or parameters matching with a respective control profile, when the respective control profile is in an active state activated by the control unit or by a user, wherein the respective control profile is activated depending on at least one condition from the following group: the stairlift device autonomously detects at least one condition or parameter being correlated with one specific of the predefined control profiles, a momentary situation falls within a predefined time frame correlated with one specific of the predefined control profiles, at least one of the components of the stairlift device is in a predefined relative position correlated with one specific of the predefined control profiles, the stairlift device is operated via remote control or joystick or user control device, and
wherein the control unit of the stairlift device is configured for activating a specific one of the plurality of predefined control profiles depending on the stairlift device autonomously detecting the at least one condition or parameter referring to at least one relative position or state of at least one component of the stairlift device.

2. The stairlift device according to claim 1, wherein the control unit of the stairlift device is configured for activating a specific one of the plurality of predefined control profiles depending on an unfolded or a folded or an unclosed or a closed state of at least one component of the stairlift device.

3. The stairlift device according to claim 1, wherein at least one of the three following individual or predefined control profiles of the plurality of predefined control profiles is stored in the data storage unit and can be retrieved by the control unit depending on at least one condition or depending on a specific user selection: standard profile, fast call/park profile, at least one customized user profile.

4. The stairlift device according to claim 1, wherein the stairlift device further comprises:
a foldable chair having at least one of the following components: a footrest, a chair leg, a seat a backrest, or an armrest;
wherein at least one specific relative position of at least one of these components is correlated with a condition or parameter or with one specific of the plurality of predefined control profiles.

5. The stairlift device according to claim 1, wherein the stairlift device further comprises:
at least the following drives: a main drive configured for driving the stairlift device along a rail, a swivel drive configured for swivelling a chair of the stairlift device, a levelling/tilting drive configured for tilting the chair;
wherein the control unit is configured for individually controlling each of these drives according to predefined settings or parameters matching with a respective control profile of the plurality of predefined control profiles, when the respective control profile is in the active state activated by the control unit or by the user.

6. The stairlift device according to claim 1, wherein at least one of the control profiles of the plurality of predefined control profiles includes a plurality of speed parameters and/or a plurality of swivel motion parameters, wherein a respective individual speed parameter and/or swivel motion parameter is correlated with at least one of a specific time frame, a specific relative position along a rail, a specific user, a specific measurement value or sensor data, presence of the user on a chair of the stairlift device, or an unfolded or a folded state of at least one component of the stairlift device.

7. The stairlift device according to claim 1, wherein the control unit of the stairlift device is configured for activating a specific one of the control profiles of the plurality of predefined control profiles depending on the stairlift device autonomously detecting at least one condition or parameter referring to any object or individual and/or to any risk of collision, wherein a sensor unit of the stairlift device providing for momentary sensor data.

8. The stairlift device according to claim 1, wherein:
the stairlift control unit is configured for controlling the stairlift device according to the plurality of predefined control profiles, such that the stairlift control unit is configured for controlling the drive unit of the stairlift device comprising the plurality of drives or actuators, wherein the stairlift control unit is configured to communicate with the drive unit, wherein at least two individual or predefined control profiles of the plurality of predefined control profiles, are stored in the stairlift control unit, wherein the stairlift control unit is configured to control at least one of the drives or actuators of the drive unit according to predefined settings or parameters matching with a respective control profile of the plurality of predefined control profiles, when the respective control profile is in the active state activated by the stairlift control unit, wherein the stairlift control unit is configured to activate the respective control profile depending on at least one condition from the following group: the stairlift control unit autonomously detects at least one condition or parameter being correlated with at least one specific of the of the plurality of predefined control profiles, a momentary situation falls within a predefined time frame correlated with at least one specific of the plurality of predefined control profiles, the stairlift control unit detects at least one of the components of the stairlift device being in a predefined relative position correlated with at least one specific of the plurality of predefined control profiles, the stairlift control unit detects the stairlift device being operated via remote control or user control device, wherein the control unit is configured for activating a specific one of the control profiles of the plurality of predefined control profiles depending on at least one autonomously detected condition or parameter referring to at least one relative position or state of at least one component of the stairlift device, depending on an unfolded or a folded or an unclosed or a closed state of at least one component of the stairlift device.

9. A method for controlling a motion of a stairlift device according to at least one movement pattern according to an individual one of a plurality of predefined control profiles, the method comprising:
controlling a drive unit of the stairlift device for carrying out at least one motion or actuation for moving or arranging the stairlift device according to a predefined path of motion by at least controlling a first drive or actuator for driving the stairlift device along a rail and positioning the stairlift device in a boarding position in a landing area;
controlling at least one further drive or actuator for moving a chair or a seat of the stairlift device around at least one spatial axis for swivelling the chair or the seat around a swivel axis and for tilting the chair or the seat around a tilting axis, respectively;
controlling at least one of the first drive or actuator or the at least one further drive or actuator according to predefined settings or parameters matching with a respective control profile of the plurality of predefined control profiles, when the respective control profile is in an active state; and
activating the respective control profile of the plurality of predefined control profiles depending on at least one condition from the following group: at least one condition or parameter being correlated with at least one specific of the plurality of predefined control profiles is autonomously detected, a momentary situation falls within a predefined time frame correlated with at least one specific of the plurality of predefined control profiles, at least one of the components of the stairlift device is detected being in a predefined relative position correlated with at least one specific of the plurality of predefined control profiles, the stairlift device is detected to be operated via user control or remote control,
wherein at least one of the three following individual or predefined control profiles of the plurality of predefined control profiles is stored in a data storage unit for being activated depending on at least one condition: a standard profile matching with the stairlift device being at least partly unfolded, a fast call/park profile matching with the stairlift device being in a completely folded state, or at least one customized user profile matching with an individual user or with a user of a predefined user group.

10. The method according to claim 9, wherein the at least one of the three following individual or predefined control profiles is stored in a data storage unit for being activated depending on a specific user selection: a standard profile matching with the stairlift device being at least partly unfolded, a fast call/park profile matching with the stairlift device being in a completely folded state, or at least one customized user profile matching with the individual user or with the user of the predefined user group.

11. The method according to claim 10, wherein at least the three following individual or predefined control profiles are stored in a data storage unit for being activated depending on at least one condition: the standard profile matching with the stairlift device being at least partly unfolded, the fast call/park profile matching with the stairlift device being in the completely folded state, and the at least one customized user profile matching with the individual user or with the user of the predefined user group.

12. The method according to claim 9, wherein at least one predefined control profile of the plurality of predefined control profiles is activated depending on detection of a folded or an unfolded state of at least one of the following components of the stairlift device: a footrest, a chair leg, a seat a backrest, and an armrest,
wherein at least one specific relative position of at least one of these components is correlated with a condition or parameter or with one specific predefined control profile of the plurality of predefined control profiles.

13. The method according to claim 9, wherein at least one of the following drives or actuators is actuated based on at least one of the control profile of the plurality of predefined control profiles: a main drive configured for driving the stairlift device along a rail, a swivel drive configured for swivelling the chair of the stairlift device, or a levelling/tilting drive configured for tilting the chair,
wherein each of these drives is individually controlled according to predefined settings or parameters matching with a respective control profile of the plurality of predefined control profiles when the respective control profile is in the active state activated by the control unit or by a user.

14. The method according to claim 9, wherein the stairlift device is controlled according to a plurality of speed parameters or a plurality of swivel motion parameters,
wherein a respective individual speed parameter or a respective swivel motion parameter is correlated with at least one of a specific time frame, a specific relative position along a rail, a specific user, a specific measurement value or sensor data, presence of a user on the chair of the stairlift device, an unfolded or a folded state of at least one component of the stairlift device.

15. (canceled)

16. A computer program comprising instructions which, when the program is executed by a control unit of a stairlift device cause the control unit to execute:
controlling a drive unit of the stairlift device for carrying out at least one motion or actuation for moving or arranging the stairlift device according to a predefined path of motion by at least controlling a first drive or actuator for driving the stairlift device along a rail and positioning the stairlift device in a boarding position in a landing area;
controlling at least one further drive or actuator for moving a chair or a seat of the stairlift device around at least one spatial axis for swivelling the chair or the seat around a swivel axis and for tilting the chair or the seat around a tilting axis;
controlling at least one of the first drive or actuator or at least one further drive or actuator according to predefined settings or parameters matching with a respective control profile, when the respective control profile is in an active state; and
activating the respective control profile depending on at least one condition from the following group: at least one condition or parameter being correlated with at least one specific of the plurality of predefined control profiles is autonomously detected, a momentary situation falls within a predefined time frame correlated with at least one specific of the plurality of predefined control profiles, at least one of the components of the stairlift device is detected being in a predefined relative position correlated with at least one specific of the plurality of predefined control profiles, or the stairlift device is detected to be operated via user control or remote control,
wherein at least one of the three following individual or predefined control profile of the plurality of predefined control profiles is stored in a data storage unit for being activated depending on at least one condition: a standard profile matching with the stairlift device being at least partly unfolded, a fast call/park profile matching with the stairlift device being in a completely folded state, or at least one customized user profile matching with an individual user or with a user of a predefined user group.

17. The computer program according to claim 16, wherein:
the plurality of predefined control profiles include a speed swivel profiles, for individually controlling at least one of the first drive or actuator or the at least one further drive or actuator of the stairlift device according to at least one movement pattern according to an individual one of the plurality of predefined control profiles wherein at least two motions or actuations for arranging the chair or the seat of the stairlift device are controlled, wherein at least the first drive is controlled for driving the stairlift device along the rail and positioning the stairlift device in the boarding position in the landing area, wherein the at least one further drive or actuator is configured for moving the chair or the seat around the at least one spatial axis, the at least one further drive or actuator is controlled for rotating the chair or the seat around the swivel axis and for tilting the chair or the seat around the tilting axis, wherein at least one of the drives or actuators is controlled according to predefined settings or parameters matching with the respective control profile, when the respective control profile is in active state.

18. The stairlift device according to claim 1, wherein:
the plurality of predefined control profiles include a speed and swivel profiles, for individually controlling at least one drive or actuator of the stairlift device according to at least one movement pattern according to an individual one of the plurality of predefined control profiles, wherein at least two motions or actuations for arranging a chair or a seat of the stairlift device are controlled, wherein at least the first drive is controlled for driving the stairlift device along a rail and positioning the stairlift device in a boarding position in a landing area, wherein the at least one further drive or actuator is configured for moving the chair or the seat around at least one spatial axis, the at least one further drive or actuator is controlled for rotating the chair or the seat around a swivel axis and for tilting the chair or the seat around a tilting axis, wherein at least one of the drives or actuators is controlled according to predefined settings or parameters matching with the respective control profile, when the respective control profile is in the active state.

19. The method according to claim 9 wherein:
the plurality of predefined control profiles include a speed and swivel profiles, for individually controlling the first drive or actuator or the at least one further drive or actuator of the stairlift device according to the at least one movement pattern according to an individual one of the plurality of predefined control profiles, wherein at least two motions or actuations for arranging the chair or the seat of the stairlift device are controlled, wherein the first drive or actuator is controlled for driving the stairlift device along the rail and positioning the stairlift device in the boarding position in the landing area, wherein the at least one further drive or actuator is configured for moving the chair or the seat around the at least one spatial axis, the at least one further drive or actuator is controlled for rotating the chair or the seat around the swivel axis and for tilting the chair or the seat around the tilting axis, wherein at least one of the first drive or actuator or the at least one further drive or actuator is controlled according to predefined settings or parameters matching with the respective control profile, when the respective control profile is in the active state.
